(19) United States
(12) Patent Application Publication
(10) Pub. No.: US 2019/0321251 A1
(43) Pub. Date: Oct. 24, 2019

(54) LIFT ASSIST DEVICE

(71) Applicants: YUN-PIN CHEN, SANXING TOWNSHIP (TW); YUN-WEI HSIEH, SANXING TOWNSHIP (TW); KUAN-CHUN CHEN, SANXING TOWNSHIP (TW)

(72) Inventors: YUN-PIN CHEN, SANXING TOWNSHIP (TW); YUN-WEI HSIEH, SANXING TOWNSHIP (TW); KUAN-CHUN CHEN, SANXING TOWNSHIP (TW)

(21) Appl. No.: 16/114,729

(22) Filed: Aug. 28, 2018

(30) Foreign Application Priority Data
Apr. 19, 2018 (TW) 107113404

(51) Int. Cl. A61H 3/00; A61H 3/04

(52) U.S. Cl. CPC A61H 3/008; A61H 2003/007; A61H 3/04; A61H 3/00

(57) ABSTRACT

A lift assist device includes a base, a lifting mechanism and a fixing unit. The base stands on the ground. The lifting mechanism is disposed at the base and moves reciprocally along a lifting direction. The fixing unit is connected with and actuated by the lifting mechanism, and the fixing unit is configured to be fixed to the body of a user. The extension line of the lifting direction is not perpendicular to the ground.

### CROSS-REFERENCE TO RELATED APPLICATION

This non-provisional application claims priority under 35 U.S.C. § 119(a) on Patent Application No. 107113404 filed in Taiwan, R.O.C. on Apr. 19, 2018, the entire contents of which are hereby incorporated by reference.

### FIELD OF THE INVENTION

The present disclosure relates to a lift assist device, and in particular to a lift assist device which is movable and lifts along an inclined direction.

### BACKGROUND OF THE INVENTION

A lift assist device is provided for disabled people or the elderly who move with difficulty. In a kind of the lift assist devices, rigid frames such as steel are set on the lower limbs of users, e.g. the medial or the lateral side of the legs, to reduce the loading on a user's muscles and bones, then support the user's body slowly. Such products are usually designed to assist the user in exerting a force during rehabilitation therapy. However, the appeal of the products is to avoid secondary injury caused by overloading, but not to bear the user's body weight. That is, the mentioned lift assist devices are not suitable for any physically unfit person because of their high demand for fitness.

Accordingly, this type of lift assist devices is not applicable to the elderly who are susceptible to osteoporosis, rheumatoid arthritis and sarcopenia, etc. In recent years, the lift assist devices that can provide additional power have been developed to help people get up by pushing the body from the bottom up.

Nevertheless, most of such lift assist devices are fixedly set on the wall of a room because of high power consumption, and this makes such products similar to a dedicated, fixed seat for users. Since the lift assist device can only provide the function of getting up at a single place, it is inconvenient that users must carry the walker with them to be able to move themselves after getting up.

Moreover, the movement trajectory of the human body from sitting to standing is rarely considered by the prior art. As a result, the lifting direction of the lift assist devices is usually designed to be vertical, causing pain to users.

### SUMMARY OF THE INVENTION

According to one aspect of the present disclosure, a lift assist device includes a base, a lifting mechanism and a fixing unit. The base stands on the ground. The lifting mechanism is disposed at the base and moves reciprocally along a lifting direction. The fixing unit is connected with and actuated by the lifting mechanism, and the fixing unit is configured to be fixed to the body of a user. The extension line of the lifting direction is not perpendicular to the ground.

### BRIEF DESCRIPTION OF THE DRAWINGS

FIG. 1 is an exploded view of a lift assist device to one embodiment of the present disclosure;

FIG. 2 is a schematic view of a fixing unit of the lift assist device of FIG. 1;

FIG. 3 is a schematic view of FIG. 1 that the lift assist device is operated to lift up the user's body;

FIG. 4 is a schematic view of FIG. 1 that the lift assist device is operated to lower the user's body;

FIG. 5 is a schematic view of FIG. 1 that the lift assist device is operated to move;

FIG. 6A is a schematic view of another embodiment of the lift assist device; and

FIG. 6B is a schematic view showing the screws drives the lifting mechanism moving along the base.

### DETAILED DESCRIPTION OF THE PREFERRED EMBODIMENTS

To make it easier for the examiner to understand the objects, characteristics and effects of this invention, we use a preferred embodiment together with the attached drawings for the detailed description of the present disclosure.

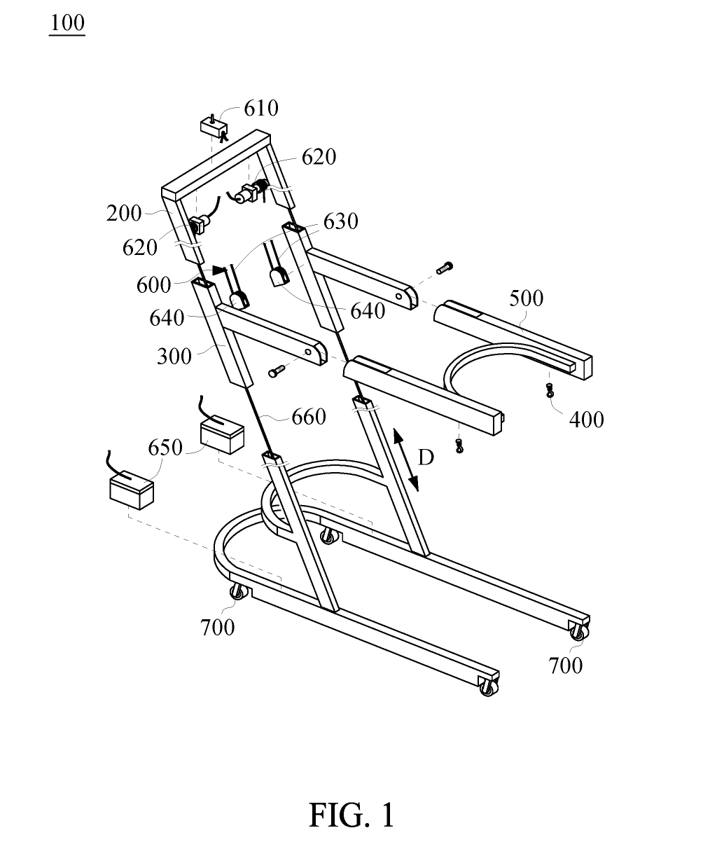

Referring to FIG. 1, the lift assist device 100 includes a base 200, a lifting mechanism 300 and a fixing unit 400. The base 200 stands on the ground. The lifting mechanism 300 is housed outside of the base 200 and able to move reciprocally relative to the base 200. As shown in FIG. 1, the portion of the base 200 for receiving the lifting mechanism 300 is inclined, and therefore the lifting direction D of the lifting mechanism 300 is also inclined.

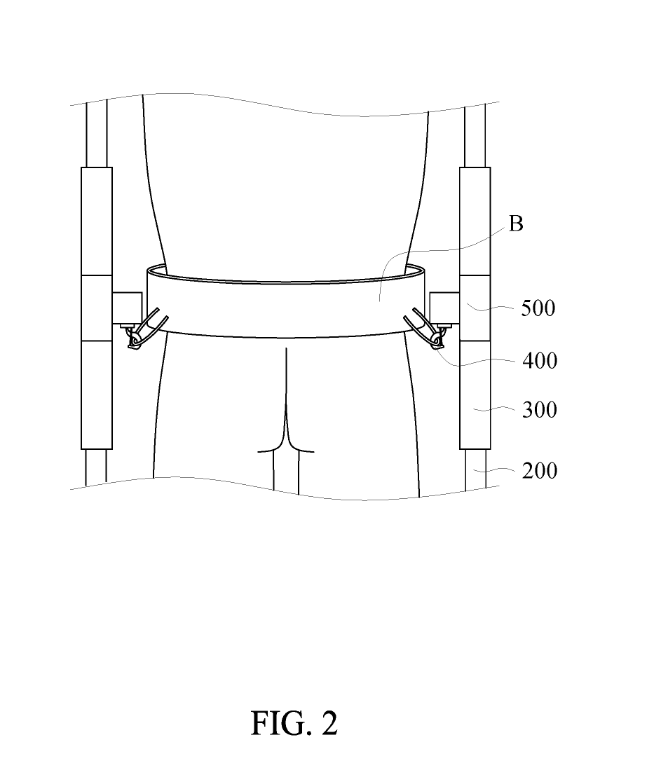

Referring to FIG. 2, the fixing unit 400 is configured to be fixed to the body of the user, such as waist, leg or chest. For the example shown in FIG. 2, the fixing unit 400 is implemented with a belt B fixed around the waist of the user. However, in other embodiments the aspect of the fixing unit 400 can be varied, for example, the belt B can be replaced by a rope, a fabric, a grip or a buckle.

The lift assist device 100 further includes a leaning unit 500 which is connected with the lifting mechanism 300. The leaning unit 500 is corresponding in position to the user. The fixing unit 400 connects the lifting mechanism 300 indirectly with the leaning unit 500. In other embodiments, the fixing unit 400 can be set on the lifting mechanism 300 directly. Consequently, the leaning unit 500 is unnecessary for connecting the fixing unit 400 and the lifting mechanism 300.

In one embodiment, the leaning unit 500 is pivotally connected to the lifting mechanism 300. As the same as the indirect connection described above, the fixing unit 400 and the leaning unit 500 of the lift assist device 100 can be replaced as different types of structures, so as to cater to different users. In addition, the above connection is also conducive to dismantling, storage, and transport to other places.

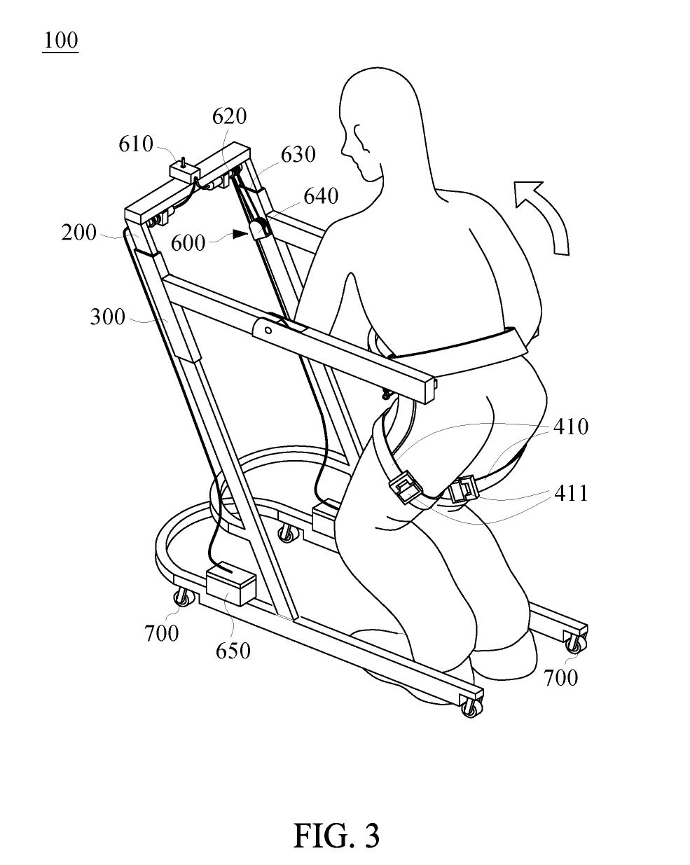

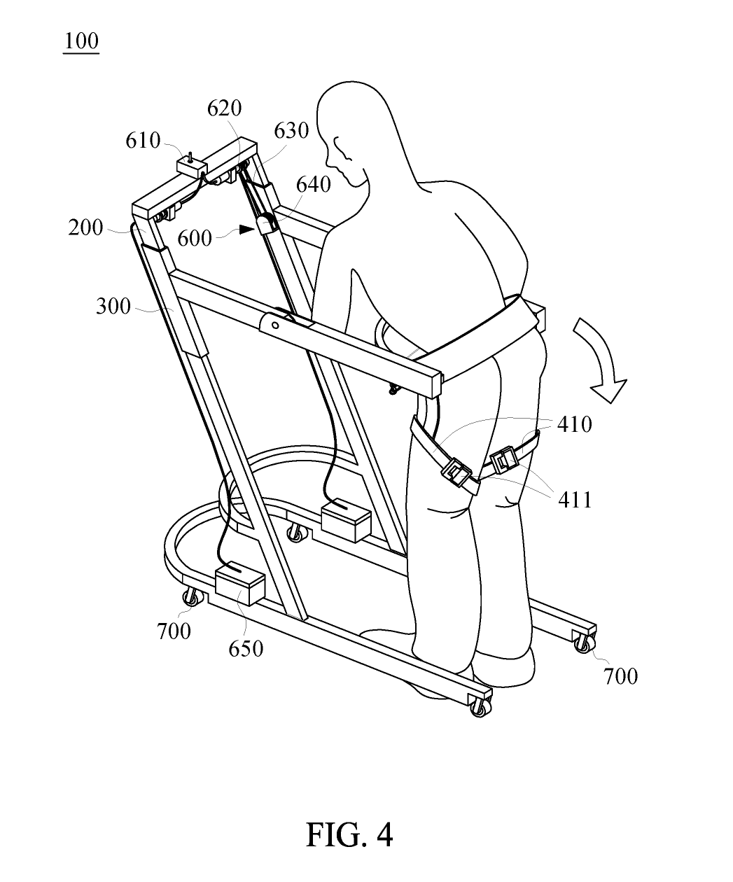

Referring to FIG. 3 and FIG. 4, since the lifting mechanism 300 is moved along the inclined base 200, the lifting direction D of the lifting mechanism 300 is not perpendicular to the ground. Accordingly, when the fixing unit 400 and the user are towed by the lifting mechanism 300, the movement trajectory of the entire system is also inclined to ergonomically switch between the sitting posture and the standing posture. In a preferred embodiment, the angle between the extension line of the lifting direction D and the ground is less than or equal to 70 degrees.

In one embodiment, to help users with lower limb weakness or suffering from a disease to get up, the lift assist device 100 further includes a power mechanism 600 which haves a controller 610, two reels 620, two pulleys 640 and a power source 650. Referring to FIG. 1, the controller 610 is disposed at the position which is convenient for the user to operate, and the reels 620 and the pulleys 640 are symmetrically set on two sides of the lifting mechanism 300.

In detail, the reels 620 and the pulleys 640 are respectively fixed to the base 200 and the lifting mechanism 300, and the reels 620 are connected to the power source 650 to receive power for driving the pulleys 640 by rigid ropes 630.

When the user operates the controller 610, the reels 620 retracts or releases the ropes 630 to change the lifting position of the pulleys 640 (i.e., the whole of the lifting mechanism 300).

The users, including the elderly and the injured, get up or sit down autonomously with the power mechanism 600. It should be particularly noted that the power mechanism 600 can be actuated by electric power, hydraulic pressure or air pressure. Moreover, the way to set the reels 620 or the pulleys 640 is not intended to limit the present disclosure. Practically, based on the product design and/or other different application requirements, the reels 620 and the pulleys 640 are not necessarily arranged in pairs.

In FIG. 3 and FIG. 4, the fixing unit 400 is provided with two straps 410 tied to the legs of human body. The straps 410 are available for assistance when the lifting mechanism 300 lifts the human body. Each of the straps 410 includes a buckle 411 for wearing or taking off, whereby making it easy for disabled users to use.

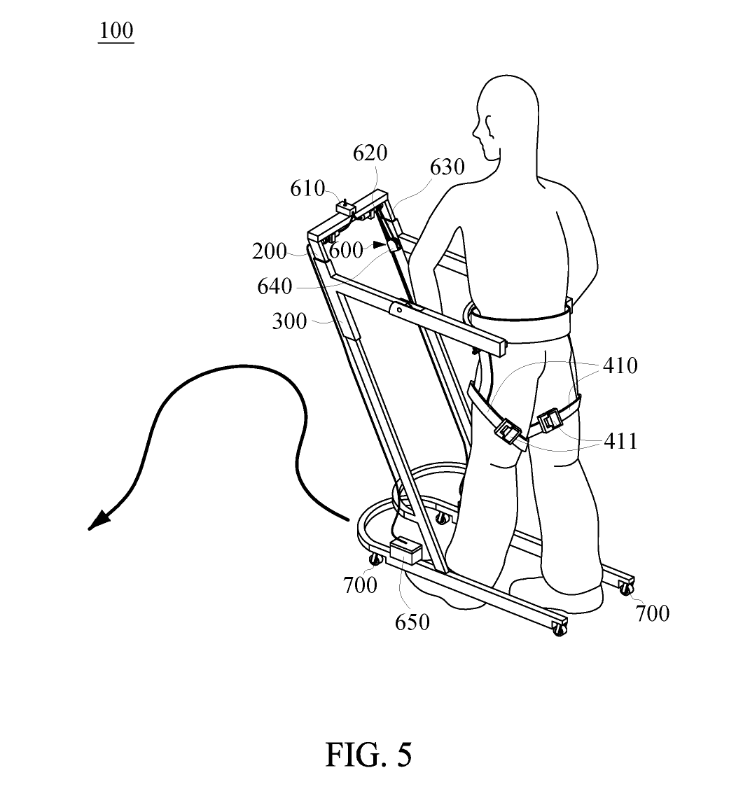

Referring to FIG. 5 with reference to FIG. 1, in one embodiment, the lift assist device 100 further includes a plurality of casters 700. The casters 700 are disposed at the bottom of the base 200 so that the base 200 is capable of moving relative to the ground. As a result, the self-care ability of the users is greatly improved since the users can not only get up without others' help, but also move around with the casters 700.

The controller 610 can be directly controlled by a switch or other wired or wireless devices. Furthermore, the controller 610 of the power mechanism 600 is optionally connected to the casters 700 which are set on the rear side of the lift assist device 100 with wires. In accordance with the embodiment, the lift assist device 100 can be controlled remotely to move to the users or the position for storage.

The technologies of the wireless remote control and the electric control method of casters are well-known, therefore the details about controlling and transmitting the casters 700 are not described herein.

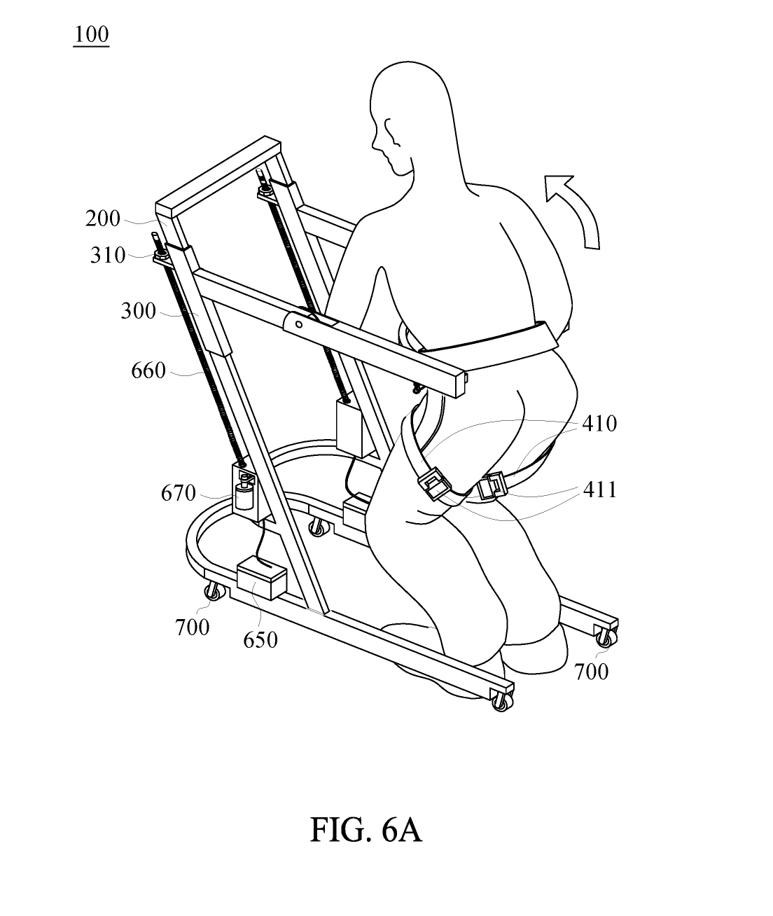

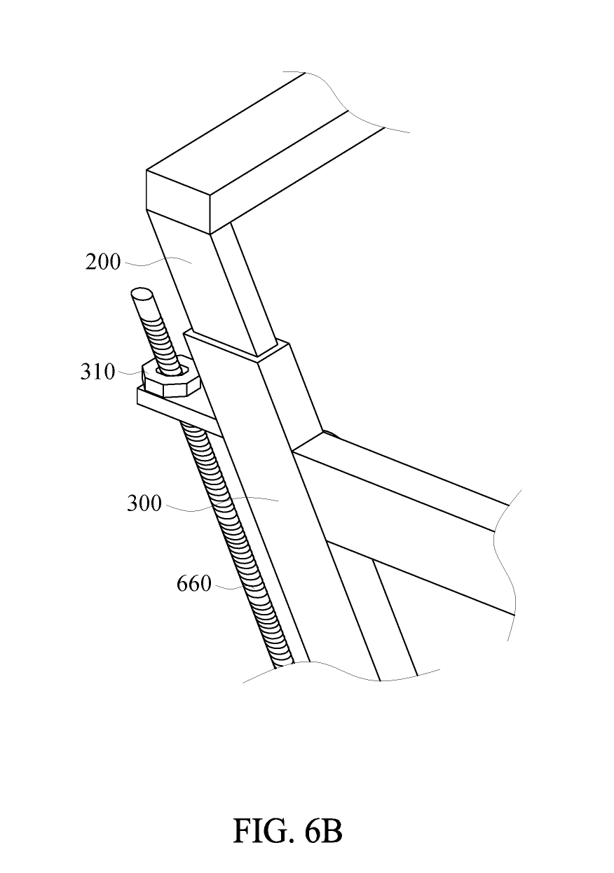

In FIG. 6A and FIG. 6B, as an alternative to the power mechanism 600, the reels 620, the ropes 630, and the pulleys 640 can be replaced as screws 660 and motors 670. The screws 660 are driven by the motors 670 respectively and connected with the lifting mechanism 300 on both sides with nuts 310 disposed thereon. The screws 660 are arranged in parallel with the lifting direction D, therefore to drive the lifting mechanism 300 moving along the base 200.

According to the embodiment, the present disclosure combines the movable base 200 with the lifting mechanism 300 to assist the users in getting up anywhere instead of the fixed position. In addition, the lift assist device 100 of the present disclosure takes into account ergonomics when the human body is switched between a sitting position and a standing position, and improves the comfort when the user gets up with a mechanical assistance.

While the invention has been described by means of specific embodiments, numerous modifications and variations could be made thereto by those skilled in the art without departing from the scope and spirit of the invention set forth in the claims.

What is claimed is:

1. A lift assist device, comprising:
a base standing on the ground;
a lifting mechanism disposed at the base and moving reciprocally along a lifting direction; and
a fixing unit connected with and actuated by the lifting mechanism, and the fixing unit being configured to be fixed to the body of a user;
wherein the extension line of the lifting direction is not perpendicular to the ground.

2. The lift assist device of claim 1, further comprising:
a plurality of casters disposed at the bottom of the base, and the casters being configured to allow the base to move relative to the ground.

3. The lift assist device of claim 1, further comprising:
a power mechanism connected with the lifting mechanism to supply energy for lifting.

4. The lift assist device of claim 3, wherein the power mechanism is actuated by electric power, hydraulic pressure or air pressure.

5. The lift assist device of claim 1, further comprising:
a leaning unit connected with the lifting mechanism and corresponding in position to the user.

6. The lift assist device of claim 5, wherein the leaning unit is detachably and pivotally connected with the lifting mechanism.

7. The lift assist device of claim 5, wherein the fixing unit is indirectly connected with the lifting mechanism with the leaning unit.

8. The lift assist device of claim 1, wherein the fixing unit is a rope, a belt, a fabric, a grip or a buckle.

9. The lift assist device of claim 1, wherein the angle between the extension line of the lifting direction and the ground is less than or equal to 70 degrees.

10. The lift assist device of claim 2, further comprising:
a plurality of wires, each of the wires connected to one of the casters; and
a power mechanism electrically connected to the casters with the wires, and the power mechanism driving the casters to rotate.
